(19) United States
(12) Patent Application Publication
(10) Pub. No.: US 2008/0080765 A1
(43) Pub. Date: Apr. 3, 2008

(54) Method and recording medium for conversion of a 3-component color space model to an N-component color space model

(76) Inventor: H. Scott Gregory, Kittery Point, ME (US)

Correspondence Address: ExxonMobil Chemical Company;Law Technology, P.O. Box 2149, Baytown, TX, 77522-2149, US

(21) Appl. No.: 11/800,391

(22) Filed: May 4, 2007

Related U.S. Application Data
(60) Provisional application No. 60/848,465, filed on Sep. 29, 2006.

(51) Int. Cl. H04N 1/46

(52) U.S. Cl. 382/167

(57) ABSTRACT

Disclosed herein is a color space model conversion method, a recording medium containing a conversion method for color space model conversion, a color space defined by applying this method, and an apparatus (e.g. a computer product) for converting images to a color space defined by applying this method.

### CROSS REFERENCE TO RELATED APPLICATIONS

This application claims the benefit of United States Provisional patent application identified as U.S. Application Ser. No. 60/848,465, filed on Sep. 29, 2006.

### BACKGROUND OF THE DISCLOSURE

Aspects of this disclosure relate to a color space model conversion method, a recording medium containing a conversion method for color space model conversion, a color space defined by applying this method, and an apparatus (e.g., a computer product) for converting documents containing color information to a color space defined by this applying this method.

### DISCUSSION OF BACKGROUND INFORMATION

Today, many people work with documents containing color information. In this context, a document containing color information is a digital file where some element(s) of the file contains color information (digital color document). Thus, a digital color document may comprise illustrations, pictures, designs, and/or colored text. One digital representation of a document containing color information is an array of pixels. In this context, a pixel is smallest discrete element in the digital file. Each pixel has a uniform color having a single color definition. This definition is represented by values in a color space. Commonly used color spaces in the packaging graphics industry define the color of each pixel as a combination of colorant values (For example, red (R), green (G), and blue (B), collectively RGB, in an additive color space, or cyan (C), magenta (M), yellow (Y), and black (B), collectively CMYK, in a subtractive color space).

For most people, there is no standard unit of measurement for color like there is for length or weight. For example, whether grass is green, dark green or light green is a matter of perception and subject to interpretation. People can draw different conclusions based on their experiences and use different descriptions to express color. Therefore, descriptions of color can be vague. Similar issues can exist for the description, verification and calibration of color as generated by an imaging device.

One method to obtain color description is to visually evaluate colors generated by the imaging device to determine if the colors are within an acceptable range. However, a problem with this approach is that the visual inspection is only subjective and not based upon a set of objective criteria.

Another approach is to quantify colors such that colors are expressed numerically and thus can be analyzed by a machine with a high degree of accuracy. In order to implement this approach, we need a color space. Color space is a term defining a method of numerically expressing a color of an object. More particularly, as used herein a color space is an N-dimensional vector representation of colors. This representation can be associated with a collection of vectors forming an N-dimensional solid having a finite volume and well-defined boundaries, which represents the color gamut, i.e., the entire scope, of the color space. Two types of color spaces are used in the present disclosure—calorimetric color space and colorant color space.

A calorimetric color space as used herein is a 3-dimensional color space where the dimensions represent neural signals generated in the retina of the human eye. In 1931, the Commission Internationale de l'Eclairage (CIE) defined a widely used calorimetric color space, CIE 1931 XYZ. XYZ tristimulus values are based on a concept that human beings perceive color by mixing the neutral signals (stimuli) of three types of cells in the retina of the eye—red cones, green cones, and blue cones. XYZ tristimulus values are charted in 3-dimensional space. For more information on the XYZ tristimulus values, see “Understanding Digital Color”, second edition, by Phil Green, published by GATF Press, pages 37-41, including specifically FIG. 2.2, the entire contents of which are herein incorporated by reference.

In 1976, CIE introduced CIE 1976 L*a*b* (CIELAB) as a colorimetric color space which is more easily related to the way individuals describe color. In L*a*b color space, L indicates lightness, i.e., having no chromaticity or color, while a and b indicate the chromaticity coordinates of a color in 3-dimensional space. Stated differently, a and b indicate color directions, i.e. +a is the red direction, −a is the green direction, +b is the yellow direction, and −b is the blue direction. When L*a*b values for a color have been assigned, that color is numerically specific under the L*a*b color space. For more information on the CIELAB, see “Understanding Digital Color”, second edition, by Phil Green, published by GATF Press, pages 41-42, the entire contents of which are herein incorporated by reference.

A colorant color space as used herein, on the other hand, is an N-dimensional color space where the dimensions represent the characteristics of physical media used to render color, such as inks, used in printing an image. Physical media used to render color is referred to herein as a colorant.

There are two basic types of colorant color spaces. One is based on additive principles. The other is based on subtractive principles. Both processes have multiple components that interact to create a range of colors (i.e., the color gamut) for the color space. The color gamut that can be created by a process is dependent on the component colors from which the color gamut is constructed. These component colors can be red (R), green (G), and blue (B) in a RGB additive process, or cyan (C), magenta (M), yellow (Y) and black (K) in a CMYK subtractive process.

For an additive process, each of the component colors is summed in relative values to create a range of colors. The component colors of an additive process (also referred to as primaries) can be, for example, red (R), green (G), and blue (B). This is the process utilized in many color displays for television and computer applications that emit light. In such devices, varying values of red, green and blue light can be summed to produce an intermediate color. The lightest colors can be created when each of the three component colors is emitting its maximum and the darkest colors can be created when each is emitting its minimum.

The color gamut of such a color space is defined by the color characteristics of the component colors. One advantage to using an additive process can be that such processes can have inherently simpler models for relating the component colors and the resulting colorimetry. By selecting theoretical (rather than physical) component colors, it is possible to construct an additive color space with a very large gamut. With such a color space, participants in the graphic arts workflow can communicate the intense colors used in graphics without resorting to “work arounds”, such as named spot colors that are printed using custom inks rather than being created by component colors. This is highly desirable for such participants.

In subtractive processes, the subtractive color components do not emit light. Instead they can absorb light selectively based on the color characteristics of each component. The lightest color in such a color space can typically be found where there are no subtractive components. Conversely, the darkest colors can typically be created by the highest concentration of all of the subtractive color components.

Printed color reproductions are typically subtractive in nature. For such applications, cyan (C) ink can be utilized to absorb reddish colors, magenta (M) ink can be utilized to absorb greenish colors, and yellow (Y) ink can be utilized to absorb bluish colors. To create black, all three inks (C, M and Y) can be combined. Typically, the black generated by these three inks is not dark enough so a fourth component, black (K) ink, can be added.

With the inclusion of black ink, some colors that have all three process colors, C, M, and Y, can be replaced with an appropriate value of black ink. This can be done to reduce the value of more expensive C, M, or Y ink or to create a color that can reproduce with more stability in certain printing processes. For this reason, the reproduction characteristics of the black component are carefully controlled and it is highly desirable for participants in the graphic arts workflow to communicate the amount of black colorant as a separate component (“black channel”).

Thus, participants in a graphics arts workflow typically communicate color separately in CMYK in order to preserve the color information contained in the black channel. Because the calorimetric models for subtractive processes can be considerably more complex than calorimetric models for additive processes, these color spaces have been built on component colors that have actual physical characteristics, and have limited color gamut. As a result, they communicate the color black well but lack the gamut required to communicate the intense colors which are frequently used in the graphics industry.

Participants in a graphics arts workflow would therefore desire to realize the large gamut of an additive colorant space with theoretical component colors, while still preserving the black color information contained in a subtractive representation of color. Therefore, there is a need for a color model to convert a three component color space model into a four or more component color space model having both a large color gamut and the ability to preserve the color information contained in the black channel. This disclosure meets this and other needs.

### SUMMARY OF THE DISCLOSURE

Aspects of this disclosure provide a method for creation of an N-component color space where N is greater than 3, comprising the step of converting a 3-component additive colorant color space having a known gamut to the N-component color space, wherein the N-component color space has the gamut of the 3-component color space.

The 3-component additive colorant color space may comprise RGB definitions selected from the group consisting of ROMM-RGB, standard RGB, or Adobe RGB. These RGB definitions comprise RGB values.

Another aspect of this disclosure is a method for converting a 3-component colorant color space, comprising Color1-Color2-Color3 (C¹C₂C₃), to a 4-component colorant color space, comprising ColorA-ColorB-ColorC-Black (C_{A}C_{B}C_{C}K), the conversion method comprising:
(a) complementing C₁, C₂ and C₃ utilizing the formulas:

C′_{A}=f₁(C₁),

C′_{B}=f₂(C₂), and

C′_{C}=f₃(C₃),
where f₁, f₂ and f₃ are continuous functions;
(b) selecting a black point K_{P} that is a selected percentage of C′_{A} combined with a selected percentage of C′_{B} combined with a selected percentage of C′_{C};
(c) creating a K value for each C′_{A}C′_{B}C′_{C} by determining if all of C′_{A}, C′_{B}, or C′_{C} are greater than or equal to the selected percentage of C′_{A}, selected percentage of C′_{B}, and selected percentage of C′_{C}, respectively and setting the value of K as follows:
   i. If all C′_{A}, C′_{B}, and C′_{C} are greater than or equal to the selected percentage of C′_{A}, selected percentage of C′_{B}, and selected percentage of C′_{C}, respectively, the value of K in the 4-component colorant color space is set to 1; or
ii. If any of C′_{A}, C′_{B}, or C′_{C} is less than the selected percentage of C′_{A}, selected percentage of C′_{B}, or selected percentage of C′_{C}, respectively, then the value of K in the 4-component colorant color space is calculated using a function of C′_{A}, C′_{B}, C′_{C}, and K_{P}; and
(d) calculating the values of C_{A}, C_{B}, and C_{C} that are used with the value of K by scaling the C′_{A}, C′_{B}, and C′_{C} values using a function of C′_{A}, C′_{B}, C′_{C}, K_{P}, and K to produce the 4-component colorant color space model,
   wherein the N-component color space has the gamut of the 3-component color space.

Still another aspect of this disclosure is a method for converting a 3-component colorant color space, comprising red, green and blue (RGB), to a 4-component colorant color space, comprising cyan, magenta, yellow and black (CMYK), the conversion method comprising:
(a) converting R, G and B to their complements of C′, M′ and Y′ utilizing the formulas:

C′=1−R,

M′=1−G,

Y′=1−B;
(b) selecting a black point (K_{P}) in the range from 0 to 1.0;
(c) determining whether (i) all of C′, M′, and Y′ are greater than or equal to the black point (K_{P}); or (ii) at least one of C′, or M′, or Y′ is less than the black point (K_{P});
(d) setting the value for K (black) either (i) to a value of 1 when all of C′, M′, and Y′ are greater than or equal to the black point (K_{P}), or (ii) to a value that is determined by dividing the minimum value of C′, M′, and Y′ by black point (K_{P}) when at least one of C′ or M′ or Y′ is less than the black point (K_{P}); and
(e) scaling C′, M′ and Y′ to produce C, M and Y utilizing the formulas:

C=(C′−(K_{P}*K))/(1−(K_{P}*K)),

M=(M′−(K_{P}*K))/(1−(K_{P}*K)), and

Y=(Y′−(K_{P}*K))/(1−(K_{P}*K)),
to produce the 4-component colorant color space comprises CMYK,
   wherein the 4-component color space has the gamut of the 3-component color space.

Still yet another embodiment of this disclosure is a method for producing a color space model that describes the relationship between a 3-dimensional colorimetric color space and an N-component colorant color space where N is greater than 3, comprising:
(a) defining a first transformation that relates a 3-dimensional calorimetric color space to a 3-component additive colorant color space having a known gamut;
(b) defining a second transformation that relates a 3-component colorant color space to an N-component colorant color space where N is greater than 3;
(c) combining the first and second transformations to define the color space model that relates a 3-dimensional colorimetric color space to an N-component colorant color space where N is greater than 3,
   wherein the N-component color space has the gamut of the 3-component color space.

Still yet another embodiment of this disclosure is a method for producing a 4-component colorant color space, the method comprising:
(a) selecting a relationship between a 3-component colorimetric color space, comprising X, Y and Z tristimulus values, and a 3-component colorant color space, comprising Color1-Color2-Color3 (C₁C₂C₃);
(b) converting the 3-component colorant color space (C₁C₂C₃) to a 4-component colorant color space, comprising ColorA-ColorB-ColorC-Black (CACBCCK), the conversion method comprising:
   (i) complementing C₁C₂C₃ utilizing the formulas:

C′_{A}=f₁(C₁),

C′_{B}=f₂(C₂), and

C′_{C}=f₃(C3),
where f₁, f₂ and f₃ are continuous functions;
(ii) selecting a black point K_{P} that is a selected percentage of C′_{A} combined with a selected percentage of C′_{B} combined with a selected percentage of C′_{C};
(iii) creating a K value for each C′_{A}C′_{B}C′_{C} by determining if all of C′_{A}, C′_{B}, or C′_{C} are greater than or equal to the selected percentage of C′_{A}, selected percentage of C′_{B}, and selected percentage of C′_{C}, respectively as follows:
   A. If all C′_{A}, C′_{B}, and C′_{C} are greater than or equal to the selected percentage of C′_{A}, selected percentage of C′_{B}, and selected percentage of C′_{C}, respectively, the value of K in the 4-component colorant color space is set to 1; or
   B. If any of C′_{A}, C′_{B}, or C′_{C} is less than the selected percentage of C′_{A}, selected percentage of C′_{B}, or selected percentage of C′_{C}, respectively, then the value of K in the 4-component colorant color space is calculated using a function of C′_{A}, C′_{B}, C′_{C}, and K_{P}; and
(c) calculating the values of C_{A}, C_{B}, and C_{C} that are used with the value of K by scaling the C′_{A}, C′_{B}, and C′_{C} values using a function of C′_{A}, C′_{B}, C′_{C}, K_{P}, and K to produce the 4-component colorant color space model;
   wherein the 4-component colorant color space has the gamut of the 3-component color space.

Still yet another embodiment of this disclosure is a method for producing a 4-component colorant color space model, the method comprising:
(a) selecting a relationship between a 3-component calorimetric color space, comprising X, Y and Z tristimulus values, and a 3-component colorant color space, comprising red, green and blue (RGB);
(b) converting the 3-component colorant color space (RGB) to a 4-component colorant color space, comprising cyan, magenta, yellow and black (CMYK), the conversion method comprising:
   (i) converting R, G and B to their complements C′, M′ and Y′ utilizing the formulas:

C′=1−R,

M′=1−G,

Y′=1−B;
(ii) selecting a black point (K_{P}) in the range of 0 to 1.0;
(iii) determining whether (i) all of C′, M′, and Y′ are greater than or equal to the black point K_{P}; or (ii) at least one of C′, or M′, or Y′ is less than the black point K_{P};
(iv) setting the value for K (black) either (i) to a value of 1 when at all of C′, M′, and Y′ are greater than or equal to the black point K_{P}, or (ii) to a value that is determined by dividing the minimum value of C′, M′, and Y′ by black point K_{P} when at least one of C′ or M′ or Y′ is less than the black point K_{P}; and
(v) scaling C′, M′ and Y′ to produce C, M and Y utilizing the formulas:

C=(C′−(K_{P}*K))/(1−(K_{P}*K)),

M=(M′−(K_{P}*K))/(1−(K_{P}*K)), and

Y=(Y′−(K_{P}*K))/(1−(K_{P}*K)),

wherein the 4-component colorant color space (CMYK) has the gamut of the 3-component color space (RGB).

In one or more embodiments of this disclosure, the black point (K_{P}) may be set in the range of 0 to 1.0; preferably the black point (K_{P}) is set in the range of 0.65 to 0.85; more preferably, the black point (K_{P}) is set to 0.80.

Embodiments of any of the methods of this disclosure further comprise the step of utilizing the N-component or 4-component colorant color space to create an ICC profile.

Embodiments of this disclosure include an ICC profile created according to any of the methods disclosed herein.

Embodiments of this disclosure include a computer readable medium, comprising the ICC profile produced by any of the methods of this disclosure.

Embodiments of this disclosure include a computer product, comprising a computer readable storage medium having a computer program stored thereon, wherein the computer program executes any of the methods of this disclosure to produce the N-component or 4-component color space.

Embodiments of this disclosure include a computer product for communicating color specifications, comprising the ICC profile produced by any of the methods of this disclosure.

Embodiments of this disclosure include a computer product for communicating color specifications (e.g. a computer or a DSP (Digital Signal Processor)), comprising a computer readable storage medium having a computer program stored thereon, wherein the computer program executes any of the methods of this disclosure.

Other exemplary aspects and advantages of this disclosure can be ascertained by reviewing the present disclosure and the accompanying drawings.

### BRIEF DESCRIPTION OF THE DRAWINGS

The drawings are only for purposes of illustrating preferred embodiments of the disclosure, and are not intended to limit the disclosure.

FIG. 1 illustrates the steps for creating an N-component color space model of this disclosure.

FIG. 2 illustrates for procedure for using the N-component color space model to create a N-component characterization.

FIG. 3 illustrates the use of the N-component characterization in the color management workflow.

### DETAILED DESCRIPTION OF THE PRESENT DISCLOSURE

The present disclosure is further described in the detailed description which follows, in reference to the noted plurality of drawings by way of non-limiting examples of aspects of this disclosure, in which like reference numerals represent similar parts throughout the several views of the drawings.

The particulars shown herein are by way of example and for purposes of illustrative discussion of aspects of this disclosure only and are presented in the cause of providing what is believed to be the most useful and readily understood description of the principles and conceptual aspects of this disclosure. In this regard, no attempt is made to show structural details of this disclosure in more detail than is necessary for the fundamental understanding of this disclosure, the description taken with the drawings making apparent to those skilled in the art how the several forms of the aspects of this disclosure may be embodied in practice.

Aspects of this disclosure can be directed to methods for communicating color in commercial graphic arts color reproduction workflows and apparatus for executing (e.g., a computer product) and storing such methods (e.g., a recording medium). Applications for this technology can be found in many aspects of publishing, advertising, and packaging. In such applications, specific color characteristics of a design or document should be effectively communicated between each of the participants in the respective workflows.

As noted in the Background, a major improvement in communicating a design's color intent can be achieved by using a single large gamut color space that can accurately represent all the color components of the design. Another important aspect of communicating the intent of the color design is to communicate both visual color and colorant information for physical media used to render color. The important key colorant information that needs to be communicated typically includes the black component of a physical media.

This disclosure provides methods and apparatus for executing and storing such methods to communicate both color and colorant information with a large gamut 4-component color space. Starting with a simple 3-component (additive process) color space having a known, large gamut, formulas were derived that map that simple model onto a 4-component (subtractive process) color space that looks and behaves like any conventional CMYK (subtractive process) color space.

Unlike virtually every other CMYK based color space, the color space of the present disclosure has component colors that are not physical, meaning they are not the result of measuring existing inks or colorants. For this approach, the color model is based on additive component colors rather than subtractive component colors. This defines a simple relationship for the colorimetry of all combinations of these additive component colors. This also defines the gamut of the resulting 4-component color space. This new color space has the additional interesting property of having a gamut that is identical to the color space based directly on the initial RGB component colors.

Aspects of this disclosure provide a method for creation of an N-component colorant color space where N is greater than 3, comprising the step of converting a 3-component additive colorant color space having a known gamut to the N-component colorant color space, wherein the N-component colorant color space has the gamut of the 3-component color space.

Aspects of this disclosure provide a method for constructing a four or more component subtractive color space model by starting with (a) a colorimetric color space (utilizing XYZ tristimulus values which represent neural signals generated in the retina of the human eye), or (b) a three component additive color space model (utilizing component colors, such as, for example, RGB) and transforming these color models to achieve the desired four or more component subtractive color model.

The 3-component additive colorant color space may comprise RGB definitions selected from the group consisting of ROMM-RGB, standard RGB, and Adobe RGB. These RGB definitions comprise RGB values.

ROMM-RGB is described in “Photography—Electronic still picture imaging-Reference Output Medium Metric RGB Color encoding: ROMM-RGB,” by PHOTOGRAPHIC AND IMAGING MANUFACTURERS ASSOCIATION, INC., referenced as PIMA 7666: 2001, dated 13 Mar. 2001 (hereinafter referred to as the “ROMM-RGB reference”), the contents of which are incorporated by reference.

Standard RGB is described in “A Standard Default Color Space for the Internet—sRGB,” by Michael Stokes (Hewlett-Packard), Matthew Anderson (Microsoft), Srinivasan Chandrasekar (Microsoft), and Ricardo Motta (Hewlett-Packard), Version 1.10, Nov. 5, 1996. (hereinafter referred to as the “Standard RGB reference”), the contents of which are incorporated by reference.

Adobe RGB color space model is described in Adobe® RGB (1998) Color Image Encoding, Adobe Systems Incorporated, May 2005, Version 2005-05 (hereinafter referred to as the “Adobe RGB reference”), the contents of which are incorporated by reference.

The N-component colorant color space may be based on subtractive component colors.

The subtractive component colors may be cyan (C), magenta (M) and yellow (Y) (collectively referred to as CMY), and a fourth component color is black (K) when N equals 4.

The subtractive component colors may be cyan (C), magenta (M), yellow (Y), orange (0) and green (G) (collectively referred to as CMYOG), and the sixth component color is black (K) when N is equal to 6.

The subtractive component colors may be cyan (C), magenta (M), yellow (Y), red (R) and green (G) (collectively referred to as CMYRGB), and the seventh component color is black (K) when N is equal to 7.

CMYOG and K is a six color process printing system having a print grid using a combination of the color black and five basic ink colors with three colors being part fluorescent to create high fidelity color reproductions, as described in U.S. Pat. No. 5,734,800 to Herbert (Pantone Inc.), incorporated herein by reference.

CMYRGB is a seven color separation process is provided in which, as well as the conventional cyan (C), magenta (M), yellow (Y) and Black (K) separations (i.e., CMYK) traditionally used in the four color printing process, additional red (R), green (G) and blue (B) separations (i.e., RGB) are produced on a conventional scanner., as described in U.S. Pat. No. 5,751,326 to Bernasconi, U.S. Pat. No. 4,812,899 to Kueppers and U.S. Pat. No. 4,878,977 to Kueppers, all of which are incorporated herein by reference.

Aspects of this disclosure provide a method for constructing a four or more component subtractive color space model by starting with (a) a calorimetric color space model (utilizing XYZ tristimulus values which represent neural signals generated in the retina of the human eye), or (b) a three component additive color space model (utilizing component colors, such as, for example, RGB) and transforming these color models to achieve the desired four or more component subtractive color model.

In some aspects of this disclosure, the color space model is produced or constructed using a mathematical relationship between the color spaces. These mathematical relationships may be based on linear algebra, including matrix mathematics. For more information on linear algebra, see “Introductory Linear Algebra, an Applied First Course”, 8th edition, by Bernard Kolman and David R. Hill, Prentice-Hall, 2005, the entire contents of which are herein incorporated by reference.

Some aspects of this disclosure are directed to a color specification, such as an ICC (International Color Consortium) profile constructed utilizing the methods of this disclosure. For more information on the ICC Profile, see “Understanding Digital Color”, second edition, by Phil Green, published by GATF Press, pages 165-191, the entire contents of which are herein incorporated by reference.

A four or more component color space model produced or constructed in accordance with the methods of this disclosure may easily represent a known, very large gamut color space based on additive component colors, and result in a distribution of colors that can be very smooth and well behaved.

One embodiment of this disclosure provides a method for producing a color space model that describes the relationship between 3-dimensional colorimetric color space and an N-component colorant color space where N is greater than 3, comprising:

(a) defining a first transformation that relates a 3-dimensional calorimetric color space to a 3-component colorant color space;
(b) defining a second transformation that relates a 3-component colorant color space to an N-component colorant color space where N is greater than 3;
(c) combining the first and second transformations to produce the color space model that relates a 3-dimensional colorimetric color space to an N-component colorant color space where N is greater than 3.

Another embodiment of this disclosure is a method for constructing a 4-component colorant color space from a 3-component colorimetric color space, the method comprising: constructing a first transform from a 3-component colorimetric color space to a 3-component colorant color space; constructing a second transform from a 3-component colorant color space to a 4-component colorant color space; combining the first and second transforms to construct the 4-component colorant color space.

Still another embodiment of this disclosure is a method for producing a 4-component colorant color space model from a 3-component colorimetric color space, the method comprising:
(a) selecting a relationship between the 3-component colorimetric color space, comprising X, Y and Z tristimulus values, and a 3-component colorant color space, comprising Color1-Color2-Color3 (C₁C₂C₃), Color1-Color2-Color3 may be any component color in an additive process, preferably red (R), green (G) and blue (B);
(b) converting the 3-component colorant color space (C₁C₂C₃) to a 4-component colorant color space, comprising ColorA-ColorB-ColorC-Black (CACBCCK), the conversion method comprising:
   (i) complementing C₁C₂C₃ utilizing the formula (1):

C′_{A}=f₁(C₁),

C′_{B}=f₂(C₂), and

C′_{C}=f₃(C₃),
where f₁, f₂ and f₃ are continuous functions, and C′_{A} is the complementary color (i.e., complement) of C₁, C′_{B} is the complementary color (i.e., complement) of C₂, and C′_{C} is the complementary color (i.e., complement) of C₃ that are used to created the value of K in accordance with this disclosure. Preferably C′_{A} is C′, C′_{B} is M′, and C′_{C} is Y′;
(ii) selecting a black point K_{P} that is a selected percentage of C′_{A} and a selected percentage of C′_{B} and a selected percentage of C′_{C}; wherein the selected percentage of C′_{A} is from 0 to 100% of the complement C′_{A}, the selected percentage of C′_{B} is from 0 to 100% of the complement C′_{B}, and the selected percentage of C′_{C} is from 0 to 100% of the complement C′_{C}.
(iii) creating a K value for each C′_{A}, C′_{B}, and C′_{C} by determining if all of C′_{A}, C′_{B}, or C′_{C} are greater than or equal to the selected percentage of C′_{A}, selected percentage of C′_{B}, and selected percentage of C′_{C}, respectively and setting the value of K as follows:
   A. If all C′_{A}, C′_{B}, and C′_{C} are greater than or equal to the selected percentage of C′_{A}, selected percentage of C′_{B}, and selected percentage of C′_{C}, respectively, the value of K in the 4-component colorant color space is set to 1; or
   B. If any of C′_{A}, C′_{B}, or C′_{C} is less than the selected percentage of C′_{A}, selected percentage of C′_{B}, or selected percentage of C′_{C}, respectively, then the value of K in the 4-component colorant color space is calculated using a function of C′_{A}, C′_{B}, C′_{C}, and K_{P}; and
(c) calculating the values of C_{A}, C_{B}, and C_{C} that are used with the value of K by scaling the C′_{A}, C′_{B}, and C′_{C} values using a function of C′_{A}, C′_{B}, C′_{C}, K_{P}, and K to produce the 4-component colorant color space model.

The combination of the selected percentages of C′_{A} and C′_{B} and C′_{C} values is used to create a black (K) color with the same visual values as the full strength black (K) component in the N-component colorant color space. In the physical world where colorants are combined by overprinting them, this would be realized by overprinting the three colorants (in the selected percentage strengths) to create a black (K) color.

The first continuous function may be any function in which the values of C′A, C′B, and C′c are calculated from the values of C′₁, C′₂, and C′₃, preferably, the first continuous function is:

C′=1−R, when C′_{A}=C and C₁=R,

M′=1−G, when C′_{B}=M and C₂,=G, and

Y′=1−B when C′_{C}=Y′ and C₃,=B.

Still yet another embodiment of this disclosure is a method for producing a 4-component colorant color space model, the method comprising:
(a) selecting a relationship between a 3-component colorimetric color space, comprising X, Y and Z tristimulus values, and a 3-component colorant color space, comprising red, green and blue (RGB);
(b) converting the 3-component colorant color space (RGB) to a 4-component colorant color space, comprising cyan, magenta, yellow and black (CMYK), the conversion method comprising:
   (i) converting R, G and B to their complements C′, M′ and Y′ utilizing the formulas:

C′=1−R,

M′=1−G, and

Y′=1−B.
(For convenience, this set of equations may be abbreviated using the formula notation “C‘M’Y′=1−RGB.” Similar notation may be used in other instances where we repeat the same operation for multiple colorants.)
(ii) selecting a black point (K_{P}) in the range of 0 to 1.0;
(iii) determining whether (i) all of C′, M′, and Y′ are greater than or equal to the black point K_{P}; or (ii) at least one of C′, or M′, or Y′ is less than the black point K_{P};
(iv) setting the value for K (black) either (i) to a value of 1 when all of C′, M′, and Y′ are greater than or equal to the black point K_{P}, or
(ii) to a value that is determined by dividing the minimum value of C′, M′, and Y′ by black point K_{P} when at least one of C′ or M′ or Y′ is less than the black point K_{P}; and
(v) scaling C′, M′ and Y′ to produce C, M and Y utilizing the formulas:

C=(C′−(K_{P}*K))/(1−(K_{P}*K)),

M=(M′−(K_{P}*K))/(1−(K_{P}*K)), and

Y=(Y′−(K_{P}*K))/(1−(K_{P}*K)).

In one or more embodiments of this disclosure, an N-component colorant color space where N is greater than 3 has the gamut of a 3-component color space (RGB). Preferably, the 4-component colorant color space (CMYK) has the gamut of the 3-component color space (RGB).

Still yet another embodiment of this disclosure is a method for converting a 3-component colorant color space, comprising Color1-Color2-Color3 (C₁C₂C₃), to a 4-component colorant color space, comprising ColorA-ColorB-ColorC-Black (CACBCCK), the conversion method comprising:
(a) complementing the C₁C₂C₃ utilizing the formulas:

C′_{A}=f₁(C₁),

C′_{B}=f₂(C₂), and

C′_{C}=f₃(C₃),
where f₁, f₂, and f₃, are continuous functions;
(b) selecting a black point K_{P} that is a selected percentage of C′A combined with a selected percentage of C′B combined with a selected percentage of C′c;
(c) creating a K value for each C′_{A}C′_{B}C′_{C} by determining if all of C′_{A}, C′_{B}, or C′_{C} are greater than or equal to the selected percentage of C′_{A}, selected percentage of C′_{B}, and selected percentage of C′_{C}, respectively and setting the value of K as follows:
   i. If all C′_{A}, C′_{B}, and C′_{C} are greater than or equal to the selected percentage of C′_{A}, selected percentage of C′_{B}, and selected percentage of C′_{C}, respectively, the value of K in the 4-component colorant color space is set to 1; or
   ii. If any of C′_{A}, C′_{B}, or C′_{C} is less than the selected percentage of C′_{A}, selected percentage of C′_{B}, or selected percentage of C′_{C}, respectively, then the value of K in the 4-component colorant color space is calculated using a function of C′_{A}, C′_{B}, C′_{C}, and K_{P}; and
(d) calculating the values of C_{A}, C_{B}, and C_{C} that are used with the value of K by scaling the C′_{A}, C′_{B}, and C′_{C} values using a function of C′_{A}, C′_{B}, C′_{C}, K_{P}, and K to produce the 4-component colorant color space model,
wherein the N-component color space has the gamut of the 3-component color space.

Still yet another embodiment of this disclosure is a method for converting a 3-component colorant color space, comprising red, green and blue (RGB), to a 4-component colorant color space, comprising cyan, magenta, yellow and black (CMYK), the conversion method comprising:
(a) converting R, G and B to their complements of C′, M′ and Y′ utilizing the formulas:

C′=1−R,

M′=1−G, and

Y′=1−B;
(b) selecting a black point (K_{P}) in the range of 0 to 1.0;
(c) determining whether (i) all of C′, M′, and Y′ are greater than or equal to the black point K_{P}; or (ii) at least one of C′, or M′, or Y′ is less than the black point K_{P};
(d) setting the value for K (black) either (i) to a value of 1 when at all of C′, M′, and Y′ are greater than or equal to the black point K_{P}, or (ii) to a value that is determined by dividing the minimum value of C′, M′, and Y′ by black point K_{P} when at least one of C′ or M′ or Y′ is less than the black point K_{P}; and
(e) scaling C′, M′ and Y′ to produce C, M and Y utilizing the formulas:

C=(C′−(K_{P}*K))/(1−(K_{P}*K)),

M=(M′−(K_{P}*K))/(1−(K_{P}*K)), and

Y=(Y′−(K_{P}*K))/(1−(K_{P}*K)),

to produce the 4-component colorant color space comprises CMYK.

In some aspects of this disclosure, ColorA-ColorB-ColorC may be any component color in an additive process, preferably Color1 is red, Color2 is green, Color3 is blue.

In some aspects of this disclosure, ColorA-ColorB-ColorC may be any component color in a subtractive process, preferably ColorA is cyan (C), ColorB is magenta (M), and ColorC is yellow (Y).

In some aspects of this disclosure, the black point K_{P} may be set in the range between 0 and 1.0, representing 0% and 100% of the black color created by a 100% combination of C′, M′ and Y′ (the complementary colors of red (R), green (G), and blue (B) that are used to create the value of K in accordance with this invention as described herein), preferably the black point K_{P} may be set at any value in the range from approximately 0.65 to 0.85, more preferably the black point K_{P} may be set at approximately 0.80.

Still yet another embodiment of this disclosure is a method for converting a 3-dimensional colorimetric color space to a 3-component color space which includes Color1-Color2-Color3 (C₁C₂C₃) data, converting that 3-component color space including Color1-Color2-Color3 (C₁C₂C₃) data to a 4-component color space including ColorA-ColorB-ColorC-Black (C_{A}C_{B}C_{C}K) data, the conversion method comprising:
(a) defining a color space model utilizing formula:

C₁C₂C₃=mat*XYZ,
where mat (described below) is a 3×3 matrix representation of the color space model that links the color space of C₁, C₂ and C₃ to the color space XYZ;
(b) complementing C₁C₂C₃ utilizing the formulas:

C′_{A}=(1−C₁),

C′_{B}=(1−C₂), and

C′_{C}=(1−C₃);
(c) selecting a black point K_{P} that is a percentage of C′_{A}, C′_{B}, and C′_{C};
(d) calculating the value of K as follows:
   i. if the values of C′_{A}, C′_{B}, and C′_{C} are all greater than or equal to the black point K_{P}, setting the value of K in the four component color space to 1; or
   ii. if any of the values of C′_{A}, C′_{B}, and C′_{C} are less than the black point K_{P}, setting the value of K in the four component color space to the minimum value of C_{A}′, C_{B}′, or C_{C}′ divided by the black point K_{P}; and
(e) calculating the value of C_{A}, C_{B}, and/or C_{C} that will go with the value of K as follows:
   i. subtracting the black point K_{P} multiplied by the value of K from each of C′_{A}, C′_{B}, and/or C′_{C} to obtain C″_{A}, C″_{B}, and C″_{C}, and
   ii. scaling the resulting C″_{A}, C″_{B}, and C″_{C} versus (1−(K_{P}*K)) whereby, when the minimum value of C_{A}′, C_{B}′, and C_{C}′ is zero, then K is zero, and in this part of color space, C_{A}′ equals C_{A}, C_{B}′ equals C_{B}, and C_{C}′ equals C_{C}.

In one embodiment, when C₁, C₂ and C₃ are based on ROMM-RGB definitions, the mat 3×3 matrix is disclosed and further details on defining the color space model are provided in the ROMM-RGB reference, described above. In another embodiment, when C₁, C₂ and C₃ are based on Standard RGB definitions, the mat 3×3 matrix is disclosed and further details on defining the color space model is provided in the Standard RGB reference, described above. In still another embodiment, when C₁, C₂ and C₃ are based on Adobe RGB definitions, the mat 3×3 matrix is defined and further details on defining the color space model is provided in the Adobe RGB reference, described above.

Some aspects of this disclosure are directed to an ICC (International Color Consortium) profile constructed utilizing any one of the methods of this disclosure, and/or to a computer readable medium storing such an ICC profile, and/or to an ICC profile transformed utilizing any one of the methods of this disclosure.

Still yet another embodiment of this disclosure is a system for constructing a color space, wherein the system executes any one of the methods of this disclosure.

Still yet another embodiment of this disclosure is a device, including, but not limited to, a computer, for executing any one of the methods of this disclosure.

Still yet another embodiment of this disclosure is directed to a computer product comprising a computer readable storage medium having a computer program stored thereon, wherein the computer program executes any one of the methods of this disclosure.

Still yet another embodiment of this disclosure is a computer readable medium storing a program for instructing one of, a computer or a DSP (Digital Signal Processor) to execute any one of the methods of this disclosure.

Still yet another embodiment of this disclosure is a computer product for communicating color specifications comprising a computer readable storage medium storing an ICC (International Color Consortium) profile constructed utilizing any one of the methods of this disclosure.

Still yet another embodiment of this disclosure is directed to a computer product for communicating color specification comprising a computer readable storage medium having a computer program stored thereon, wherein the computer program executes any one of the methods of this disclosure.

Still yet another embodiment of this disclosure is directed to any one of the above methods, wherein the first and second transformations are combined to define a third transformation of a color space model that relates a 3-dimensional colorimetric color space to an 4-component colorant color space; utilizing the third transformation to create the color space model; and then utilizing the color space model to create an ICC profile.

Other exemplary aspects and advantages of this disclosure can be ascertained by reviewing the present disclosure and the accompanying drawings.

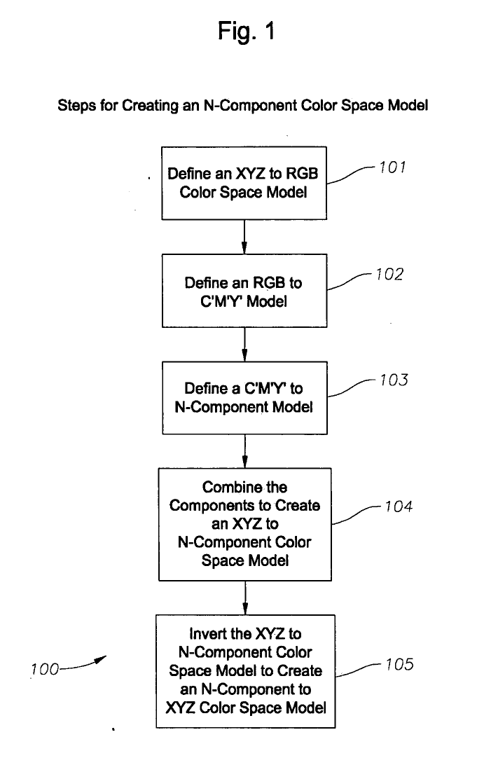

Referring now to the drawings, FIG. 1 illustrates a process 100 to create an N-component colorant color space model, starting from a 3-component calorimetric color space model (XYZ to RGB) and a transformation of the 3-component colorant color space to a 4-component colorant color space model (RGB to CMYK).

In step 101 of FIG. 1, a 3-component calorimetric color space to 3-component additive colorant color space model (e.g., XYZ to RGB color space model) is defined in accordance with the methods of this disclosure.

In step 102, a 3-component additive color space to a 3-component subtractive colorant color space model (e.g., RGB to C′M‘Y’ model) is defined in accordance with the methods of this disclosure.

In step 103, a 3-component subtractive colorant color space to an N-component subtractive colorant color space model (e.g., C′M′Y′ to CMYK, when N equals 4, component model) is defined in accordance with the methods of this disclosure.

In step 104, the 3-component colorimetric color space to 3-component additive colorant color space model (e.g., XYZ to RGB color space model) is combined with the 3-component additive color space to the 3-component subtractive colorant color space model (e.g., RGB to C′M‘Y’ model) and 3-component subtractive colorant color space to an N-component subtractive colorant color space model (e.g., C′M′Y′ to CMYK, when N equals 4, component model) to create an 3-component colorimetric color space to 4-component subtractive colorant color space model (e.g., XYZ to CMYK, when N is equal to 4) in accordance with the methods of this disclosure.

In step 105, the 3-component calorimetric color space to 4-component subtractive colorant color space model (e.g., XYZ to CMYK, when N is equal to 4) is inverted to create a N-component colorant color space to the 3-component colorimetric color space model (e.g. CMYK, when N is equal to 4, to XYZ) in accordance with the methods of this disclosure.

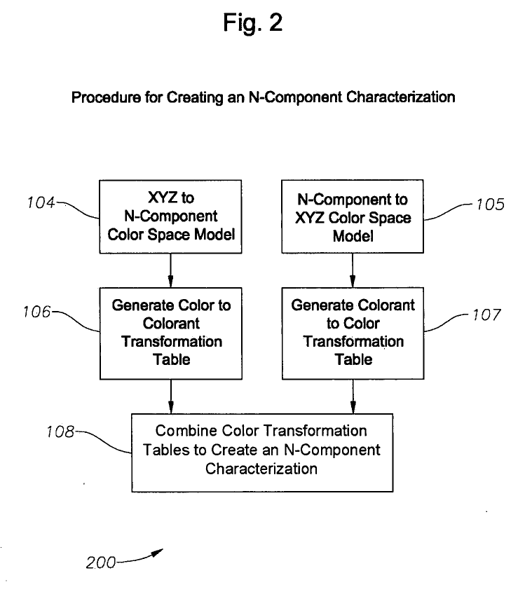

FIG. 2 illustrates a procedure 200 for creating an N-component characterization from the 3-component colorimetric, color space to 4-component subtractive colorant color space model (e.g., XYZ to CMYK, when N is equal to 4) of step 104 and the N-component colorant color space to the 3-component calorimetric color space model (e.g. CMYK, when N is equal to 4, to XYZ) of step 105 above.

In step 106, a transformation table is generated from the 3-component colorimetric color space to 4-component subtractive colorant color space model (e.g., XYZ to CMYK, when N is equal to 4).

In step 107, a table is generated of the N-component colorant color space to the 3-component calorimetric color space model (e.g. CMYK, when N is equal to 4, to XYZ).

In step 108, the tables of step 106 and step 107 are combined to create an N-component characterization. In one embodiment, this characterization is an ICC profile.

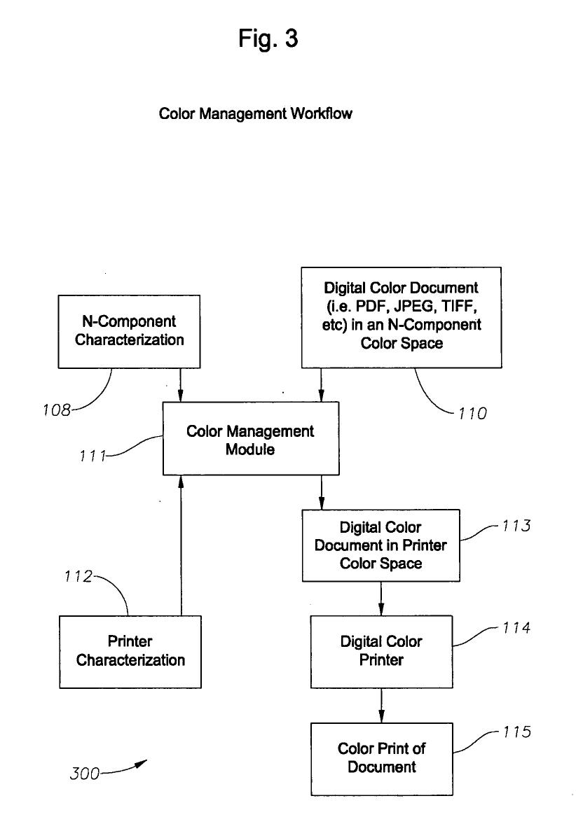

FIG. 3 illustrates the process 300 of the color management work flow in which the N-component characterization 108 is used to manage color in a typical graphics workflow.

The centerpiece of a color managed workflow is the color management module 111. In the workflow of FIG. 3, the starting point is the digital color document 110. A digital color document is a document that contains color information in a digital file (i.e., PDF, JPEG, TIFF, etc.) where some elements of the file contains color information. A digital color document may comprise illustrations, pictures, designs, and/or color text. The digital color document 110 color is defined in the N-component color space in accordance with the methods of this disclosure.

In order to interpret the color represented in the digital document 110, the color management module 111 requires a characterization of the N-component color space 108. The color management module 111 utilizes the N-component characterization 108 to transform each color defined in the digital document 110 from its N-component representation to a XYZ tristimulus value to a digital color document in printer color space 113.

The objective of the color managed workflow in FIG. 3 is to print the digital document 110 on a digital color printer 114 in a way that preserves the true colors originally captured in the digital document 110. To accomplish this objective, the color management module 111 needs an additional characterization, namely the printer characterization 112.

Printer characterization 112 provides the transform between the color space of the printer and the calorimetric color space. With the printer characterization 112 loaded into the color management module 111, the color management module further processes the digital color document by transforming each color from the XYZ tristimulus values generated above into colorant values in digital document in the printer color space 113.

The digital color printer 114 completes the color management workflow 300 by interpreting the colorant values in the digital document in the printer color space 113 into machine instructions and acting on these instructions to print a color accurate output document as color print 115.

As illustrated in the Examples below, a 4-component colorant color space, like CMYK, is created by first transforming colorimetric (XYZ) values to colorant (RGB) values in a 3-component colorant color space. The RGB values are then complemented into the RGB components (1-RGB). If the RGB space to be modeled has a nonlinearity associated with it, the RGB components are converted in accordance with a method of this disclosure. This result is referred to as C′M′Y′.

A black point (K_{P}) is set at approximately 80% for the Example shown below.

In an N-dimensional colorant color space (C₁ . . . Cₙ₋₁, K) the black point K_{P} as used herein is defined as the point at which specified values of C₁ . . . Cₙ₋₁ equal the full strength of the black ink (K).

If all the values of C′, M′, and Y′ are greater than or equal to the black point K_{P}, then the value of K in the 4-component color space will be set to 1. If at least one of the values of C′, M′, or Y′ is less than the black point K_{P}, then the value of K in the 4-component colorimetric color space is the minimum value of C′, M′, or Y′ divided by the black point K_{P}.

To calculate the values of C, M, and Y that will go with the value of K that has been determined, the C′, M′, and Y′ values are blended with the value of K that is scaled by the black point K_{P}. This blending is accomplished by subtracting the black point K_{P} times the value of K from each C′, M′, or Y′ and dividing that result by (1−(K_{P}*K)). This means that when the minimum value of C′, M′, and Y′ is zero, then K is zero, and in this part of color space, the C′ equals C, M′ equals M, and Y′ equals Y. A 4-component CMYK colorant color space may be converted back to a 3-component calorimetric color space by the reverse method as more fully described in the Example.

The 4-component CMYK colorant color space that results from this simple transformation is, by its nature, very smooth and well behaved. These are very important attributes for a color space that is going to be utilized to exchange color information. Color data that goes into this color space needs to come out with little or no change or they will corrupt the color reproduction intent.

This 4-component CMYK colorant color space can exploit desirable characteristics of the typical CMYK subtractive color spaces utilizing a simple 3-component additive model. This provides methods and apparatus to execute and store such methods to communicate a wide range of colors not limited by the characteristics of physical colorants.

The present disclosure addresses the need for a 4-component large gamut color space that can effectively communicate the black component of a document. This color space becomes very effective for exchanging color information because it can accurately represent any element in a color document including spot colors (i.e., a color generated by an ink (pure or mixed) that is printed using a single station), as well as any critical aspect of a specific colorant.

### EXAMPLE 1

This example shows how colorimetric XYZ values are transformed to colorant RGB values in a 3-component additive colorant color space, and how this data is passed through the C′M‘Y’ (the complements of RGB) to produce colorant CMYK values in a 4-component subtractive color space in accordance with this disclosure.

In this Example, we begin by choosing ten (10) colors that may be used in an image. The matrix of XYZ values for these colors is summarized in Table 1 below:

TABLE 1
Starting XYZ Values

| Color | X | Y | Z |
|---|---|---|---|
| 1-Cyan | 0.1665 | 0.7120 | 0.8249 |
| 2-Magenta | 0.8290 | 0.2881 | 0.8249 |
| 3-Yellow | 0.9329 | 0.9999 | 0.0000 |
| 4-Medium Grey | 0.2769 | 0.2872 | 0.2369 |
| 5-Blue | 0.0313 | 0.0001 | 0.8249 |
| 6-Deep Green | 0.0388 | 0.2044 | 0.0000 |
| 7-Dull Yellow | 0.2679 | 0.2871 | 0.0000 |
| 8-Medium Grey | 0.2769 | 0.2872 | 0.2369 |
| 9-Charcoal Grey | 0.0153 | 0.0158 | 0.0131 |
| 10-Black | 0.0000 | 0.0000 | 0.0000 |

These colorimetric XYZ values are first converted to linear colorant R′G′B′ values by applying the formula (1):

rgb_linear=xyz*xyz2rgb_matrix (1)

Where the xyz2rgb_matrix is:

$$\begin{matrix}1.34595230887995 & & - 0.54459736929617 & & 0.00000000000000 \\ - 0.2556092001099 & & 1.50816316329401 & & 0.00000000000000 \\ - .05111210794457 & & 0.02053508502015 & & 1.21228264890862\end{matrix}$$

The linear colorant R′G‘B’ values are converted to the nonlinear colorant RGB values used in the art by applying the following formula (2):

rgb_nonlinear=rgb_linear̂(1/1.8) (2)

Further details of the conversion of the linear colorant R′G′B′ values to the nonlinear colorant RGB values (using xyz2rgb_matrix) is found in the ROMM-RGB reference, disclosed above.

The nonlinear colorant RGB values are obtained by multiplying the XYZ matrix in Table 1 by the xyz2rgb_matrix shown above, and then applying formula (7) to the resulting R, G, and B values as summarized in Table 2 below:

TABLE 2
RGB Values

| Color | R | G | B |
|---|---|---|---|
| 1-Cyan | 0.0000 | 1.0000 | 1.0000 |
| 2-Magenta | 1.0000 | 0.0000 | 1.0000 |
| 3-Yellow | 1.0000 | 1.0000 | 0.0000 |
| 4-Medium Grey | 0.5000 | 0.5000 | 0.5000 |
| 5-Blue | 0.0000 | 0.0000 | 1.0000 |
| 6-Deep Green | 0.0000 | 0.5000 | 0.0000 |
| 7-Dull Yellow | 0.5000 | 0.5000 | 0.0000 |
| 8-Medium Grey | 0.5000 | 0.5000 | 0.5000 |
| 9-Charcoal Grey | 0.1000 | 0.1000 | 0.1000 |
| 10-Black | 0.0000 | 0.0000 | 0.0000 |

C′M′Y′ is complemented from the RGB data for each color according to the formulas:

C′=1−R (3)

M′=1−G (4)

Y′=1−B (5)

The result is shown as an array of C′M‘Y’ triples in Table 3 below:

TABLE 3
Starting C′M′Y′ Values

| Color | C′ | M′ | Y′ |
|---|---|---|---|
| 1-Cyan | 1.0000 | 0 | 0 |
| 2-Magenta | 0 | 1.0000 | 0 |
| 3-Yellow | 0 | 0 | 1.000 |
| 4-Medium Grey | 0.5000 | 0.5000 | 0.5000 |
| 5-Blue | 1.0000 | 1.0000 | 0 |
| 6-Deep Green | 1.0000 | 0.5000 | 1.0000 |
| 7-Dull Yellow | 0.5000 | 0.5000 | 1.0000 |
| 8-Medium Grey | 0.5000 | 0.5000 | 0.5000 |
| 9-Charcoal Grey | 0.9000 | 0.9000 | 0.9000 |
| 10-Black | 1.0000 | 1.0000 | 1.0000 |

In the array of C′M′Y′ triples above, the left column represents C′, the center column represents M′, and the right column represents Y′.

Next, we calculate the minimum value for each C′M′Y′ triple in Table 3. The result is shown in Table 4 below:

TABLE 4

| Color | Minimum Value |
|---|---|
| 1-Cyan | 0 |
| 2-Magenta | 0 |
| 3-Yellow | 0 |
| 4-Medium Grey | 0.5000 |
| 5-Blue | 0 |
| 6-Forest Green | 0.5000 |
| 7-Dull Yellow | 0.5000 |
| 8-Medium Grey | 0.5000 |
| 9-Charcoal Grey | 0.9000 |
| 10-Black | 1.0000 |

The next step is to build a black (K) component or black channel. We begin by choosing the black point (K_{P}). In this example the black point was set at 0.80; however, this is for exemplary purposes only.

With the black point set, the next step is to create a black channel by calculating the amount of black (K value) for each color. The K values are calculated using the following procedure:

(1). Identify the colors where the minimum value of all of C′, Y′, and M′ is greater than or equal to the value of the black point. In our example, only two colors (Charcoal Grey and Black) satisfy these criteria. Set K=1.0000 for these colors.

(2). For the remaining colors, scale the K channel by first finding the minimum of C′, Y′, and M′. Set K=Min(C′, Y′, M′)/K_{P}.

### Table 5 shows the result of applying this procedure to the data in Table 3.

TABLE 5
K Values For Sample Colors

| Color | K |
|---|---|
| 1-Cyan | 0 |
| 2-Magenta | 0 |
| 3-Yellow | 0 |
| 4-Medium Grey | 0.6250 |
| 5-Blue | 0 |
| 6-Forest Green | 0.6250 |
| 7-Dull Yellow | 0.6250 |
| 8-Medium Grey | 0.6250 |
| 9-Charcoal Grey | 1.0000 |
| 10-Black | 1.0000 |

Finally, calculate the values of C, M, and Y using the following formulas:

C=(C′−(K_{P}*K))/(1−(K_{P}*K)), (6)

M=(M′−(K_{P}*K))/(1−(K_{P}*K)), and (7)

Y=(Y′−(K_{P}*K))/(1−(K_{P}*K)). (8)

For example, to calculate the C value for Color 9 (Charcoal Grey) we substitute the values C′=0.9 (from Table 3), K_{P}=0.8, and K=1 (from Table 5) to arrive at a value of 0.5000 as follows:

C=(0.9000−(0.8000*1.000))/(1.000−(0.8000*1.000))=0.5000 (9)

The CMYK color space thus constructed is as follows:

TABLE 6

CMYK Color Values

| Color | C | M | Y | K |
|---|---|---|---|---|
| 1-Cyan | 1.0000 | 0 | 0 | 0 |
| 2-Magenta | 0 | 1.0000 | 0 | 0 |
| 3-Yellow | 0 | 0 | 1.000 | 0 |
| 4-Medium Grey | 0 | 0 | 0 | 0.6250 |
| 5-Blue | 1.0000 | 1.0000 | 0 | 0 |
| 6-Forest Green | 1.0000 | 0 | 1.0000 | 0.6250 |
| 7-Dull Yellow | 0 | 0 | 1.0000 | 0.6250 |
| 8-Medium Grey | 0 | 0 | 0 | 0.6250 |
| 9-Charcoal Grey | 0.5000 | 0.5000 | 0.5000 | 1.000 |
| 10-Black | 1.0000 | 1.000 | 1.000 | 1.000 |

Where the first column represents C, the second column represents M, the third column represents Y, and the fourth column represents K, when the columns are read from left to right. Thus, beginning with XYZ values in Table 1 an image comprising ten (10) colors defined using the 4-component colorant color space (CMYK) values of Table 6, to demonstrate one aspect of this disclosure.

### EXAMPLE 2

This example demonstrates the reverse transform of CMYK values in a 4-component colorant color space to XYZ values in a calorimetric color space and how this data is passed through C′M′Y′ in accordance with an embodiment of this disclosure.

We begin with the CMYK values shown in Table 6 above. Recall that the black point K_{P} associated with these values in 0.8.

For each set of CMYK values in this table, we first calculate the minimum value (x). The result of this calculation is summarized in Table 7 below:

TABLE 7
Minimum (x) Values For Sample Colors

| Color | Minimum Value |
|---|---|
| 1-Cyan | 0 |
| 2-Magenta | 0 |
| 3-Yellow | 0 |
| 4-Medium Grey | 0 |
| 5-Blue | 0 |
| 6-Forest Green | 0 |
| 7-Dull Yellow | 0 |
| 8-Medium Grey | 0 |
| 9-Charcoal Grey | 0.5000 |
| 10-Black | 1.0000 |

Now, calculate C′, M′, and Y′ values corresponding to each set of CMYK values by applying the following formulas:

C′=K_{P}*K+(1−K_{P}*K)*C*(1−(1−K_{P})*x*(1−K)), (10)

M′=K_{P}*K+(1−K_{P}*K)*M*(1−(1−K_{P})*x*(1−K)), and (11)

Y′=K_{P}*K+(1−K_{P}*K)*Y*(1−(1−K_{P})*x*(1−K)). (12)

For example, color #6 (Deep Green−1.000, 0.000, 1.000, 0.6250) becomes:

C′=0.8*0.6250+(1−0.8*0.6250)*1.000*(1−(1−0.8)*0*(1−0.6250))=1.0000 (13)

M′=0.8*0.6250+(1−0.8*0.6250)*0.000*(1−(1−0.8)*0*(1−0.6250))=0.5000 (14)

Y′=0.8*0.6250+(1−0.8*0.6250)*1.000*(1−(1−0.8)*0*(1−0.6250))=1.0000 (15)

Applying this procedure to each of the CMYK values in Table 7 yields the following result:

TABLE 8
C′M′Y′ Values

| Color | C′ | M′ | Y′ |
|---|---|---|---|
| 1-Cyan | 1.0000 | 0 | 0 |
| 2-Magenta | 0 | 1.0000 | 0 |
| 3-Yellow | 0 | 0 | 1.000 |
| 4-Medium Grey | 0.5000 | 0.5000 | 0.5000 |
| 5-Blue | 1.0000 | 1.0000 | 0 |
| 6-Deep Green | 1.0000 | 0.5000 | 1.0000 |
| 7-Dull Yellow | 0.5000 | 0.5000 | 1.0000 |
| 8-Medium Grey | 0.5000 | 0.5000 | 0.5000 |
| 9-Charcoal Grey | 0.9000 | 0.9000 | 0.9000 |
| 10-Black | 1.0000 | 1.000 | 1.000 |

We complement the C′M‘Y’ values in Table 8 using formula 16 below:

RGB=1−C′M′Y′ (16)

### The resulting nonlinear RBG values are shown in Table 9.

TABLE 9
RGB Values

| Color | R | G | B |
|---|---|---|---|
| 1-Cyan | 0.0000 | 1.0000 | 1.0000 |
| 2-Magenta | 1.0000 | 0.0000 | 1.0000 |
| 3-Yellow | 1.0000 | 1.0000 | 0.0000 |
| 4-Medium Grey | 0.5000 | 0.5000 | 0.5000 |
| 5-Blue | 0.0000 | 0.0000 | 1.0000 |
| 6-Deep Green | 0.0000 | 0.5000 | 0.0000 |
| 7-Dull Yellow | 0.5000 | 0.5000 | 0.0000 |
| 8-Medium Grey | 0.5000 | 0.5000 | 0.5000 |
| 9-Charcoal Grey | 0.1000 | 0.1000 | 0.1000 |
| 10-Black | 0.0000 | 0.0000 | 0.0000 |

Now convert the nonlinear RGB values to linear R′G‘B’ values by applying the formula (17):

Linear_{—}R′G′B′=Nonlinear_{—}RGB̂1.8 (17)

Then transform the linear R′G′B′ values to XYZ values by applying the formula (18):

xyz=Linear_{—}R′G′B′*rgb2xyz_matrix (18)

Where rgb2xyz_matrix is:

$$\begin{matrix}0.79766960589891 & & 0.28803831011975 & & 0.00000000000000 \\ 0.13519207387679 & & 0.71187605818330 & & 0.00000000000000 \\ 0.03134120108368 & & 0.00008563169695 & & 0.82489013671875\end{matrix}$$

The rgb2xyz_matrix is the inverse of the xyz2rgb_matrix described in Example 1.

The resulting colorimetric XYZ values are shown in Table 10 below:

TABLE 10
XYZ Values

| Color | X | Y | Z |
|---|---|---|---|
| 1-Cyan | 0.1665 | 0.7120 | 0.8249 |
| 2-Magenta | 0.8290 | 0.2881 | 0.8249 |
| 3-Yellow | 0.9329 | 0.9999 | 0.0000 |
| 4-Medium Grey | 0.2769 | 0.2872 | 0.2369 |
| 5-Blue | 0.0313 | 0.0001 | 0.8249 |
| 6-Deep Green | 0.0388 | 0.2044 | 0.0000 |
| 7-Dull Yellow | 0.2679 | 0.2871 | 0.0000 |
| 8-Medium Grey | 0.2769 | 0.2872 | 0.2369 |
| 9-Charcoal Grey | 0.0153 | 0.0158 | 0.0131 |
| 10-Black | 0.0000 | 0.0000 | 0.0000 |

Thus, beginning with CMYK values from the 4-component colorant color space in Table 6 an image comprising ten (10) colors may be defined as the XYZ values of Table 10, to demonstrate another aspect of this disclosure.

It is noted that the foregoing examples have been provided merely for the purpose of explanation and are in no way to be construed as limiting of this disclosure. While this disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of this disclosure in its aspects. Although this disclosure has been described herein with reference to particular means, materials and embodiments, this disclosure is not intended to be limited to the particulars disclosed herein; rather, the present disclosure extends to all functionally equivalent structures, methods and uses, such as are within the scope of the appended claims.

What is claimed is:

1. A method for creation of an N-component colorant color space where N is greater than 3, comprising the step of converting a 3-component additive colorant color space having a known gamut to the N-component colorant color space, wherein the N-component colorant color space has the gamut of the 3-component additive color space.

2. The method of claim 1, wherein the 3-component additive colorant color space comprises RGB definitions.

3. The method of claim 2, wherein the RGB definitions are selected from the group consisting of ROMM-RGB, standard RGB and Adobe RGB.

4. The method of claim 1, wherein the N-component colorant color space comprises subtractive component colors.

5. The method of claim 4, wherein the subtractive component colors is CMY and a fourth component color is black (K) when N equals 4.

6. The method of claim 4, wherein the subtractive component colors is CMYOG and the sixth component color is black (K) when N is equal to 6.

7. The method of claim 4, wherein the subtractive component colors is CMYRGB and the seventh component color is black (K) when N is equal to 7.

8. The method of claim 5, further comprising the step of utilizing the 4-component colorant color space to create an ICC profile.

9. An ICC profile created according to the method of claim 8.

10. A computer readable medium, comprising the ICC profile of claim 9.

11. A computer product, comprising a computer readable storage medium having a computer program stored thereon, wherein the computer program executes the method of claim 1 to produce the N-component color space.

12. A computer product for communicating color specifications, comprising the ICC profile of claim 9.

13. A computer product for communicating color specifications, comprising a computer readable storage medium having a computer program stored thereon, wherein the computer program executes the method of claim 1.

14. A method for converting a 3-component colorant color space, comprising Color1-Color2-Color3 (C₁C₂C₃), to a 4-component colorant color space, comprising ColorA-ColorB-ColorC-Black (C_{A}C_{B}C_{C}K), the conversion method comprising:
(a) complementing C₁, C₂ and C₃ utilizing the formulas:
C′_{A}=f₁(C₁),
C′_{B}=f₂(C₂), and
C′_{C}=f₃(C₃),
where f₁, f₂ and f₃ are continuous functions;
(b) selecting a black point K_{P} that is a selected percentage of C′_{A} combined with a selected percentage of C′_{B} combined with a selected percentage of C′_{C};
(c) creating a K value for each C′_{A}C′_{B}C′_{C} by determining if all of C′_{A}, C′_{B}, or C′_{C} are greater than or equal to the selected percentage of C′_{A}, selected percentage of C′_{B}, and selected percentage of C′_{C}, respectively and setting the value of K as follows:
i. If all C′_{A}, C′_{B}, and C′_{C} are greater than or equal to the selected percentage of C′_{A}, selected percentage of C′_{B}, and selected percentage of C′_{C}, respectively, the value of K in the 4-component colorant color space is set to 1; or
ii. If any of C′_{A}, C′_{B}, or C′_{C} is less than the selected percentage of C′_{A}, selected percentage of C′_{B}, or selected percentage of C_{C}, respectively, then the value of K in the 4-component colorant color space is calculated using a function of C′_{A}, C′_{B}, C′_{C}, and K_{P}; and
(d) calculating the values of C_{A}, C_{B}, and C_{C} that are used with the value of K by scaling the C′_{A}, C′_{B}, and C′_{C} values using a function of C′_{A}, C′_{B}, C′_{C}, K_{P}, and K to produce the 4-component colorant color space model,
wherein the N-component color space has the gamut of the 3-component color space.

15. The method of claim 14, further comprising the step of utilizing the N-component colorant color space model to create an ICC profile.

16. An ICC profile created according to the method of claim 15.

17. A computer readable medium, comprising the ICC profile of claim 16.

18. A computer product, comprising a computer readable storage medium having a computer program stored thereon, wherein the computer program executes the method of claim 14 to produce the N-component color space.

19. A computer product for communicating color specifications, comprising the ICC profile of claim 16.

20. A computer product for communicating color specifications, comprising a computer readable storage medium having a computer program stored thereon, wherein the computer program executes the method of claim 14.

21. A method for converting a 3-component colorant color space, comprising red, green and blue (RGB), to a 4-component colorant color space, comprising cyan, magenta, yellow and black (CMYK), the conversion method comprising:
(a) converting R, G and B to their complements of C′, M′ and Y′ utilizing the formulas:
C′=1−R,
M′=1−G, and
Y′=1−B;
(b) selecting a black point (K_{P}) in the range from 0 to 1.0;
(c) determining whether (i) all of C′, M′, and Y′ are greater than or equal to the black point (K_{P}); or (ii) at least one of C′, or M′, or Y′ is less than the black point (K_{P});
(d) setting the value for K (black) either (i) to a value of 1 when at all of C′, M′, and Y′ are greater than or equal to the black point (K_{P}), or (ii) to a value that is determined by dividing the minimum value of C′, M′, and Y′ by black point (K_{P}) when at least one of C′ or M′ or Y′ is less than the black point (K_{P}); and
(e) scaling C′, M′ and Y′ to produce C, M and Y utilizing the formula:
C=(C′−(K_{P}*K))/(1−(K_{P}*K)),
M=(M′−(K_{P}*K))/(1−(K_{P}*K)), and
Y=(Y′−(K_{P}*K))/(1−(K_{P}*K)),
to produce the 4-component colorant color space comprises CMYK,
wherein the 4-component color space has the gamut of the 3-component color space.

22. The method of claim 21, wherein the black point (K_{P}) is in the range of 0.65 to 0.85.

23. The method of claim 21, wherein the black point (K_{P}) is 0.80.

24. The method of claim 19, further comprising the step of utilizing the N-component colorant color space to create an ICC profile.

25. An ICC profile created according to the method of claim 24.

26. A computer readable medium, comprising the ICC profile of claim 25.

27. A computer product, comprising a computer readable storage medium having a computer program stored thereon, wherein the computer program executes the method of claim 21 to produce the 4-component color space.

28. A computer product for communicating color specifications, comprising the ICC profile of claim 25.

29. A computer product for communicating color specifications, comprising a computer program stored thereon, wherein the computer program executes the method of claim 21.

30. A method for producing a color space model that describes the relationship between a 3-dimensional calorimetric color space and an N-component colorant color space where N is greater than 3, comprising:
(a) defining a first transformation that relates 3-dimensional colorimetric color space to a 3-component additive colorant color space having a known gamut;
(b) defining a second transformation that relates a 3-component colorant color space to an N-component colorant color space where N is greater than 3;
(c) combining the first and second transformations to define the color space model that relates a 3-dimensional calorimetric color space and an N-component colorant color space where N is greater than 3,
wherein the N-component color space has the gamut of the 3-component color space.

31. The method of claim 30, wherein the 3-dimensional colorimetric color space comprises XYZ tristimulus values.

32. The method of claim 30, wherein the 3-component colorant color space comprises additive component colors.

33. The method of claim 32, wherein the additive component colors comprise RGB definitions.

34. The method of claim 33, wherein the RGB definitions are selected from the group consisting of ROMM-RGB, standard RGB and Adobe RGB.

35. The method of claim 30, wherein the N-component colorant color space comprises subtractive component colors.

36. The method of claim 35, wherein the subtractive component colors is CMY and a fourth component color is black (K) when N equals 4.

37. The method of claim 35, wherein the subtractive component colors is CMYOG and the sixth component color is black (K) values when N is equal to 6.

38. The method of claim 35, wherein the subtractive component colors is CMYRGB and the seventh component color is black (K) values when N is equal to 7.

39. The method of claim 36, further comprising the step of utilizing the N-component colorant color space to create an ICC profile.

40. An ICC profile created according to the method of claim 39.

41. A computer readable medium, comprising the ICC profile of claim 40.

42. A computer product, comprising a computer readable storage medium having a computer program stored thereon, wherein the computer program executes the method of claim 30 to produce the N-component color space.

43. A computer product for communicating color specifications, comprising the ICC profile of claim 40.

44. A computer product for communicating color specifications, comprising a computer readable storage medium having a computer program stored thereon, wherein the computer program executes the method of claim 30.

45. A method for producing a 4-component colorant color space, the method comprising:
(a) selecting a relationship between a 3-component colorimetric color space, comprising X, Y and Z tristimulus values, and a 3-component colorant color space, comprising Color1-Color2-Color3 (C₁C₂C₃);
(b) converting the 3-component colorant color space (C₁C₂C₃) to a 4-component colorant color space, comprising ColorA-ColorB-ColorC-Black (CACBCCK), the conversion method comprising:
(i) complementing C₁C₂C₃ utilizing the formulas;
C′_{A}=f₁(C₁),
C′_{B}=f₂(C₂), and
C′_{C}=f₃(C₃),
where f₁, f₂ and f₃ are continuous functions;
(ii) selecting a black point K_{P} that is a selected percentage of C′_{A} combined with a selected percentage of C′_{B} combined with a selected percentage of C′_{C};
(iii) creating a K value for each C′_{A}C′_{B}C′_{C} by determining if all of C′_{A}, C′_{B}, or C′_{C} are greater than or equal to the selected percentage of C′_{A}, selected percentage of C′_{B}, and selected percentage of C′_{C}, respectively as follows:
A. If all C′_{A}, C′_{B}, and C′_{C} are greater than or equal to the selected percentage of C′_{A}, selected percentage of C′_{B}, and selected percentage of C′_{C}, respectively, the value of K in the 4-component colorant color space is set to 1; or
B. If any of C′_{A}, C′_{B}, or C′_{C} is less than the selected percentage of C′_{A}, selected percentage of C′_{B}, or selected percentage of C′_{C}, respectively, then the value of K in the 4-component colorant color space is calculated using a function of C′_{A}, C′_{B}, C′_{C}., and K_{P}; and
(c) calculating the values of C_{A}, C_{B}, and C_{C} that are used with the value of K by scaling the C′_{A}, C′_{B}, and C′_{C} values using a function of C′_{A}, C′_{B}, C′_{C}, K_{P}, and K to produce the 4-component colorant color space model;
wherein the 4-component colorant color space has the gamut of the 3-component color space.

46. The method of claim 39, further comprising the step of utilizing the 4-component colorant color space to create an ICC profile.

47. An ICC profile created according to the method of claim 46.

48. A computer readable medium, comprising the ICC profile of claim 47.

49. A computer product, comprising a computer readable storage medium having a computer program stored thereon, wherein the computer program executes the method of claim 45 to produce the 4-component color space.

50. A computer product for communicating color specifications, comprising the ICC profile of claim 47.

51. A computer product for communicating color specifications, comprising a computer readable storage medium having a computer program stored thereon, wherein the computer program executes the method of claim 45.

52. A method for producing a 4-component colorant color space model, the method comprising:
(a) selecting a relationship between a 3-component colorimetric color space, comprising X, Y and Z tristimulus values, and a 3-component colorant color space, comprising red, green and blue (RGB);
(b) converting the 3-component colorant color space (RGB) to a 4-component colorant color space, comprising cyan, magenta, yellow and black (CMYK), the conversion method comprising:
(i) converting R, G and B to their complements C′, M′ and Y′ utilizing the formulas:
C′=1−R,
M′=1−G, and
Y′=1−B;
(ii) selecting a black point (K_{P}) in the range of 0 to 1.0;
(iii) determining whether (i) all of C′, M′, and Y′ are greater than or equal to the black point K_{P}; or (ii) at least one of C′, or M′, or Y′ is less than the black point K_{P};
(iv) setting the value for K (black) either (i) to a value of 1 when at all of C′, M′, and Y′ are greater than or equal to the black point K_{P}, or (ii) to a value that is determined by dividing the minimum value of C′, M′, and Y′ by black point K_{P} when at least one of C′ or M′ or Y′ is less than the black point K_{P}; and
(v) scaling C′, M′ and Y′ to produce C, M and Y utilizing the formulas:
C=(C′−(K_{P}*K))/(1−(K_{P}*K)),
M=(M′−(K_{P}*K))/(1−(K_{P}*K)), and
Y=(Y′−(K_{P}*K))/(1−(K_{P}*K)),
wherein the 4-component colorant color space (CMYK) has the gamut of the 3-component color space (RGB).

53. The method of claim 52, wherein the black point (K_{P}) is in the range of 0.65 to 0.85.

54. The method of claim 52, wherein the black point (K_{P}) is 0.80.

55. The method of claim 52, further comprising the step of utilizing the 4-component colorant color space to create an ICC profile.

56. An ICC profile created according to the method of claim 55.

57. A computer readable medium, comprising the ICC profile of claim 56.

58. A computer product, comprising a computer readable storage medium having a computer program stored thereon, wherein the computer program executes the method of claim 52 to produce the 4-component color space.

59. A computer product for communicating color specifications, comprising the ICC profile of claim 56.

60. A computer product for communicating color specifications, comprising a computer readable storage medium having a computer program stored thereon, wherein the computer program executes the method of claim 52.
